(19) United States
(12) Patent Application Publication
(10) Pub. No.: US 2021/0332545 A1
(43) Pub. Date: Oct. 28, 2021

(54) UNIVERSAL FRAMING SYSTEM FOR A BOAT DOCK AND METHOD OF BUILDING A BOAT DOCK THEREFROM

(71) Applicant: DeanDock, LLC, Denver, NC (US)

(72) Inventor: Luke MILLER, Maiden, NC (US)

(21) Appl. No.: 17/242,297

(22) Filed: Apr. 27, 2021

Related U.S. Application Data
(60) Provisional application No. 63/016,881, filed on Apr. 28, 2020.

(51) Int. Cl. E02B 3/06; B63C 5/02

(52) U.S. Cl. CPC E02B 3/068; B63C 5/02; E02B 3/064

(57) ABSTRACT

A universal framing system for a boat dock generally includes at least one standardized dock frame. The standardized dock frame is in a rectangular shape. Each of the standardized dock frames include a standardized left side member, a standardized right side member, a standardized front end member, and a standardized back end member. The standardized left side member may be on a left side of the rectangular shape. The standardized right side member is on a right side of the rectangular shape. The standardized front end member is on a front end of the rectangular shape. The standardized back end member is on a back end of the rectangular shape. The standardized left side member, the standardized right side member, the standardized front end member, and the standardized back end member are configured to connect together to create the rectangular shape.

### CROSS-REFERENCE TO RELATED APPLICATIONS

This application claims priority to U.S. Provisional Patent Application No. 63/016,881 filed on Apr. 28, 2020 entitled “Universal Framing System for Boat Docks”, which is incorporated herein by reference in its entirety.

### FIELD OF THE DISCLOSURE

The present disclosure is related to boat docks and methods of building boat docks. More specifically, the present disclosure is directed to a universal framing system for boat docks to allow boat dock builders to assemble frames for boat docks in a quicker and more efficient manner. The disclosed universal framing system for boat docks universal design may allow for projects with decking material to be installed on 16″ or 24″ centers with just one frame type.

### BACKGROUND

Generally speaking, in the United States, a dock is a wooden platform built over water, with one end secured to the shore. The platform is used for the boarding and offloading of small boats. In American English, a dock is technically synonymous with pier or wharf—any human-made structure in the water intended for people to be on. However, in modern use, pier is generally used to refer to structures originally intended for industrial use, such as seafood processing or shipping, and more recently for cruise ships, and dock is used for almost everything else, often with a qualifier, such as ferry dock, swimming dock, ore dock and others. However, pier is also commonly used to refer to wooden or metal structures that extend into the ocean from beaches and are used, for the most part, to accommodate fishing in the ocean without using a boat.

Every boat needs a place to call home. Out on the lake, you will see many different kinds of boat docks. Each one comes with its own distinct advantages and drawbacks. When most people imagine a dock on the lake, they envision a piling dock. Piling docks are built by driving heavy wooden beams known as “pilings” (think telephone poles, but shorter) deep into the bed of the lake. The frame is then attached to the pilings, forming a sturdy, wooden walkway. Piling docks typically are costly per square foot, depending on the installation. Piling docks also cannot rise or fall with the level of the lake. Factors such as lake depth, climate and local regulations can increase or decrease the cost of installation. Piling docks have the advantage of stability and strength. Homeowners can build them in high-flow areas such as rivers and streams, since piling docks are less likely to be washed away by floodwaters. The main downside for piling docks is cost, both of installation and maintenance.

Floating docks cost less than piling docks and are much more versatile. These consist of an anchored, floating platform of large, airtight drums, onto which a wooden platform is built. The structure floats on the water's surface but is large and stable enough to serve as a boat dock. Floating docks have the advantages of versatility and lower cost. Most floating boat docks cost less per square foot and typically require less square footage than a piling dock. Floating boat docks automatically rise and fall according to the lake level. You can also tow them out of the lake in the winter, or for repairs. On the downside, floating docks are less stable. They shift with the current and are more likely to be washed away by floodwaters. Floating boat docks work well for smaller boats, such as fishing boats, or for those with a limited budget.

The instant disclosure recognizes the problem with installing both piling and floating docks. The process is labor intensive and can differ from one manufacturer and/or installer to the next. As such, there is clearly a need to provide an easier more uniform system and method for installing boat docks.

The instant disclosure may be designed to address at least certain aspects of the problems or needs discussed above by providing a universal framing system for boat docks and a method of building a boat dock therefrom.

### SUMMARY

The present disclosure may solve the aforementioned limitations of the currently available boat dock frames and methods of building boat docks by providing a universal framing system for a boat dock. The universal framing system for a boat dock generally may include at least one standardized dock frame. The standardized dock frame may be in a rectangular shape. Each of the standardized dock frames can include a standardized left side member, a standardized right side member, a standardized front end member, and a standardized back end member. The standardized left side member may be on a left side of the rectangular shape. The standardized right side member may be on a right side of the rectangular shape. The standardized front end member may be on a front end of the rectangular shape. The standardized back end member may be on a back end of the rectangular shape. The standardized left side member, the standardized right side member, the standardized front end member, and the standardized back end member may be configured to connect together to create the rectangular shape.

One feature of the disclosed universal framing system may be that each of the at least one standardized dock frames may be configured to be assembled together with each other for creating the boat dock.

Another feature of the disclosed universal framing system may be that each of the at least one standardized dock frames may be configured to be modular. The modular feature of the standardized dock frames may be where a base standardized dock frame of the at least one standardized dock frames can be configured to be attached to at least one adjacent standardized dock frame of the at least one standardized dock frames. This attachment of the two standardized dock fames may be both in a lengthwise direction and in a widthwise direction.

Another feature of the disclosed universal framing system may be that each of the at least one standardized dock frames can include a pattern of holes. The pattern of holes may be around the rectangular shape. The pattern of holes may be configured for attaching each of the at least one standardized dock frames to one another. As a result, the base standardized dock frame may be configured to be attached to the at least one adjacent standardized dock frame by using the included pattern of holes. The pattern of holes being around the rectangular shape may allow the attachment of the standardized dock frames to be both in the lengthwise direction and in the widthwise direction. In select embodiments, the pattern of holes may include a plurality of attachment holes and a plurality of slots around the rectangular shape. In select embodiments, the pattern of holes may include at least one standard pattern. The standard pattern may include, but is not limited to, having a central slot and a plurality of surrounding holes around the central slot. Wherein, the standard pattern may be repeated around the rectangular shape. In select embodiments, the standard pattern may include the central slot, and four surrounding holes around the central slot. These four surrounding holes may create a box shape of the surrounding holes around the central slot. Wherein the plurality of holes, the plurality of slots, or a combination thereof may be configured for attaching flotation devices or accessories around the boat dock.

Another feature of the disclosed universal framing system may be that the included plurality of slots may be oval pockets. These oval pockets may be configured as fork pockets (like for standard forklifts) for easy transport, with galvanized relief holes.

In select embodiments of the universal framing system, the standardized left side member may include a left top lip with a plurality of left top holes. The standardized right side member may include a right top lip with a plurality of right top holes. The standardized front end member may include a front top lip with a plurality of front top holes. And the standardized back end member including a back top lip with a plurality of back top holes. Wherein, a rectangular top lip having a plurality of rectangular top holes may be created via the left top lip, the right top lip, the front top lip, and the back top lip. Wherein, the rectangular top holes may be configured for attaching decking material on top of the rectangular shape of each of the at least one standardized dock frames.

In other select embodiments of the universal framing system, the standardized left side member may include a left bottom lip with a plurality of left bottom holes. The standardized right side member may include a right bottom lip with a plurality of right bottom holes. The standardized front end member may include a front bottom lip with a plurality of front bottom holes. And the standardized back end member including a back bottom lip with a plurality of back bottom holes. Wherein, a rectangular bottom lip having a plurality of rectangular bottom holes may be created via the left bottom lip, the right bottom lip, the front bottom lip, and the back bottom lip. Wherein, the rectangular bottom holes may be configured for attaching decking material on bottom of the rectangular shape of each of the at least one standardized dock frames. Wherein, each of the at least one standardized dock frames may be configured to be reversible where the rectangular top lip or the rectangular bottom lip may be configured to be positioned upwards for attaching decking material on each of the at least one standardized dock frames. In select embodiments, the rectangular top holes and the rectangular bottom holes may have a standard spacing. The standard spacing may include, but is not limit to, a standard spacing of 1 foot.

In other select embodiments of the universal framing system, the standardized left side member and the standardized right side member may include end protrusions. Or, the standardized front end member and the standardized back end member may include the end protrusions. Wherein, the end protrusions may be configured for attaching together the standardized left side member, the standardized right side member, the standardized front end member, and the standardized back end member to create the rectangular shape.

Another feature of the disclosed universal framing system may be that the rectangular shape of each of the standardized dock frames may include a length and a width. In select possibly preferred embodiments, the length may be 10 feet, and the width may be 4 feet. Wherein, the standardized left side member and the standardized right side member have the length of 10 feet each with a pattern of holes including 10 standard patterns. And the standardized front end member and the standardized back end member may have the width of 4 feet each with a pattern of holes including 4 standard patterns.

Another feature of the disclosed universal framing system may be the inclusion of at least one triangulated center truss. The triangulated center truss may be configured to be used to support decking material. In select embodiments, each of the at least one triangulated center trusses may include a flat top member, a left angled side, and a right angled side. The left angled side may be connected to the flat top member at a left triangle top and may have a flat left bottom member attached to an opposite left bottom. The right angled side may be connected to the flat top member at a right triangle top and may have a flat right bottom member attached to an opposite right bottom. The flat top member may include top flanges that extend beyond the left angled side and the right angled side on both top ends. The top flanges may be configured for attaching the flat top member to the rectangular top lip of the standardized dock frame. The flat left bottom member and the flat right bottom member may include bottom flanges that extend beyond the left angled side and the right angled side on both bottom ends. The bottom flanges may be configured for attaching the left angled side and the right angled side to the rectangular bottom lip of the standardized dock frame. Wherein, the left angled side and the right angled side create a triangular shape for supporting the flat top member.

One feature of the disclosed universal framing system may be that in select embodiments each of the left angled side and the right angled side may include at least one elongated slot and/or a top slot. The at least one elongated slots may be aligned with a plurality of slots along the standardized left side member and the standardized right side member. Whereby the elongated slots may be configured as fork pockets with the plurality of slots (like for transportation with standard fork lifts). The top slot may be positioned just below the flat top member. The top slot may be configured to receive a diagonal x-brace therethrough.

Another feature of the disclosed universal framing system may be that in select embodiments at least two triangulated center trusses may be included attached lengthwise. In these embodiments, a flat top center brace may be included that can be configured to support the top flanges of adjacent triangulated center trusses. A bottom center brace may also be included that is configured to support the bottom flanges of the left angled side and the right angled side. The bottom center brace may include a vertical member configured to space and align the adjacent triangulated center trusses.

In select embodiments of the disclosed universal framing system, when the rectangular shape of the at least one standardized dock frame has a width of four feet, the at least one standardized dock frame may include one triangulated center truss between the width of the standardized dock frame configured to allow decking material to be installed on 24″ centers.

In select other embodiments of the disclosed universal framing system, when the rectangular shape of the at least one standardized dock frame has a width of four feet, the at least one standardized dock frame may include two triangulated center trusses between the width of the standardized dock frame configured to allow decking material to be installed on 16″ centers.

Another feature of the disclosed universal framing system may be that each of the standardized dock frames may further include diagonal x-braces therethrough. Wherein each of the diagonal x-braces may be configured to be attached diagonally from a left top lip to a right top lip of the rectangular shape of the standardized dock frame. In select embodiments, each of the diagonal x-braces may pass through a top slot of a triangulated center truss. Wherein, each of the diagonal x-braces may be configured for added structural support.

In another aspect, the instant disclosure embraces the standardized dock frame of the disclosed universal framing system for a boat dock. The standardized dock frame may include any of the embodiments and/or combination of embodiments shown and/or described herein.

In another aspect, the instant disclosure embraces a method of building a boat dock. The disclosed method of building a boat dock may include utilizing the disclosed universal framing system in any of the embodiments and/or combination of embodiments shown and/or described herein. As such, the disclosed method of building a boat dock may generally include providing at least one standardized dock frame in any of the embodiments and/or combination of embodiments shown and/or described herein. As such, each of the provided standardized dock frames may include: a standardized left side member on a left side of the rectangular shape; a standardized right side member on a right side of the rectangular shape; a standardized front end member on a front end of the rectangular shape; and a standardized back end member on a back end of the rectangular shape. With the provided components of the standardized dock frame, the disclosed method of building a boat dock may further include connecting together to create a rectangular shape the standardized left side member on a left side of the rectangular shape, the standardized right side member on a right side of the rectangular shape, the standardized front end member on a front end of the rectangular shape, and the standardized back end member on a back end of the rectangular shape. Once connected, the disclosed method may further include assembling together each of the at least one standardized dock frames with one another for creating the boat dock, and attaching decking material to the assembled standardized dock frames.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 shows a perspective view of a standardized dock frame according to select embodiments of the disclosed universal framing system for a boat dock;

FIG. 2 shows a side view of a standardized left side member or a standardized right side member according to select embodiments of the instant disclosure for use on the standardized dock frame of FIG. 1, prior to the top and bottom lips being bent perpendicular;

FIG. 3 shows a side view of a standardized front end member or a standardized back end member according to select embodiments of the instant disclosure for use on the standardized dock frame of FIG. 1, prior to the top and bottom lips being bent perpendicular;

FIG. 4 shows a perspective view of a triangulated center truss according to select embodiments of the instant disclosure for use on the standardized dock frame of FIG. 1;

FIG. 5 shows a perspective view of a boat dock according to select embodiments of the instant disclosure assembled utilizing two of the standardized dock frames of FIG. 1 assembled together in a widthwise direction;

FIG. 6 shows a perspective view of a boat dock according to select embodiments of the instant disclosure assembled utilizing two of the standardized dock frames of FIG. 1 assembled together in a lengthwise direction;

FIG. 7 shows a perspective view of a boat dock according to select embodiments of the instant disclosure assembled utilizing four of the standardized dock frames of FIG. 1 assembled together in both a lengthwise and a widthwise direction;

FIG. 8 shows a perspective view of a boat dock according to select embodiments of the instant disclosure assembled utilizing two of the standardized dock frames of FIG. 1 assembled together in a widthwise direction with decking material being installed;

FIG. 9 shows a perspective view of a boat dock according to select embodiments of the instant disclosure assembled utilizing four of the standardized dock frames of FIG. 1 assembled together in both a lengthwise and a widthwise direction with decking material installed; and

FIG. 10 shows a flow chart of the disclosed method of building a boat dock according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

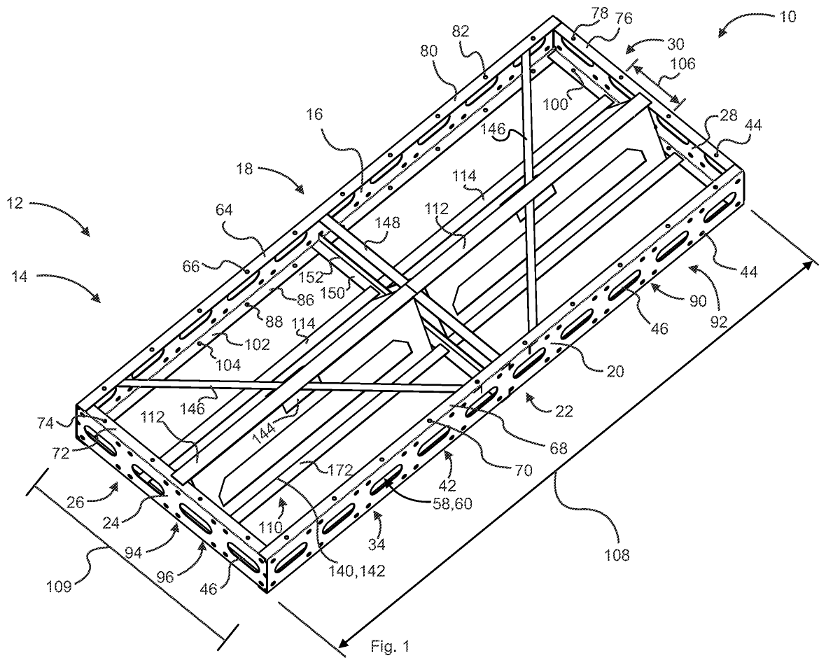

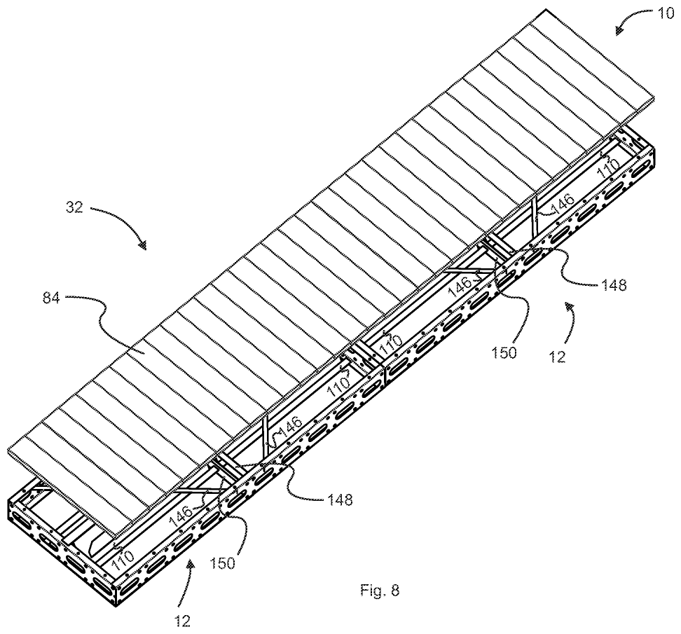

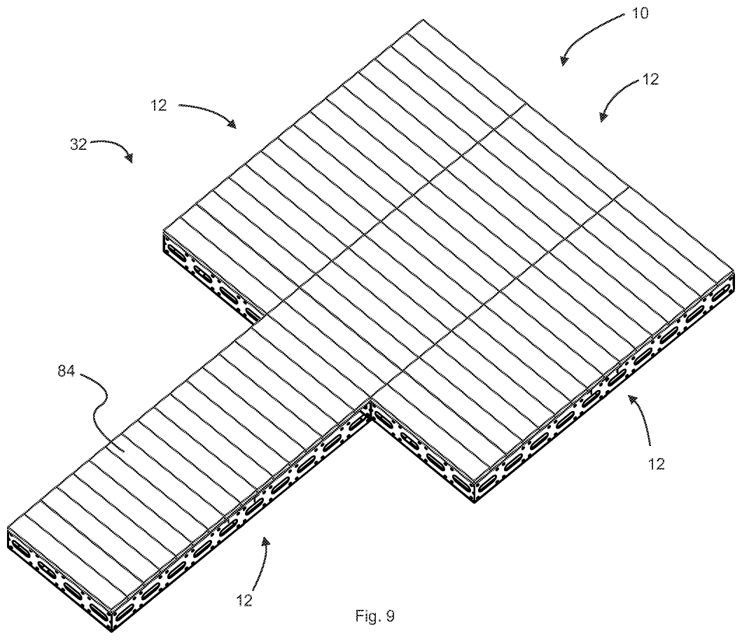

Referring now to FIGS. 1-10, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring now specifically to FIGS. 1-9, the present disclosure may solve the aforementioned limitations of the currently available boat dock frames and methods of building boat docks by providing universal framing system 10 (see FIGS. 1-4) for boat dock 32 (see FIGS. 5-9). Universal framing system 10 for boat dock 32 generally may include at least one standardized dock frame 12. Standardized dock frame 12 may be in rectangular shape 14. Each of the standardized dock frames 12 can include standardized left side member 16, standardized right side member 20, standardized front end member 24, and standardized back end member 28. Standardized left side member 16 may be on left side 18 of rectangular shape 14. Standardized right side member 20 may be on right side 22 of rectangular shape 14. Standardized front end member 24 may be on front end 26 of rectangular shape 14. Standardized back end member 28 may be on back end 30 of rectangular shape 14. As shown best in FIG. 1, standardized left side member 16, standardized right side member 20, standardized front end member 24, and standardized back end member 28 may be configured to connect together to create rectangular shape 14.

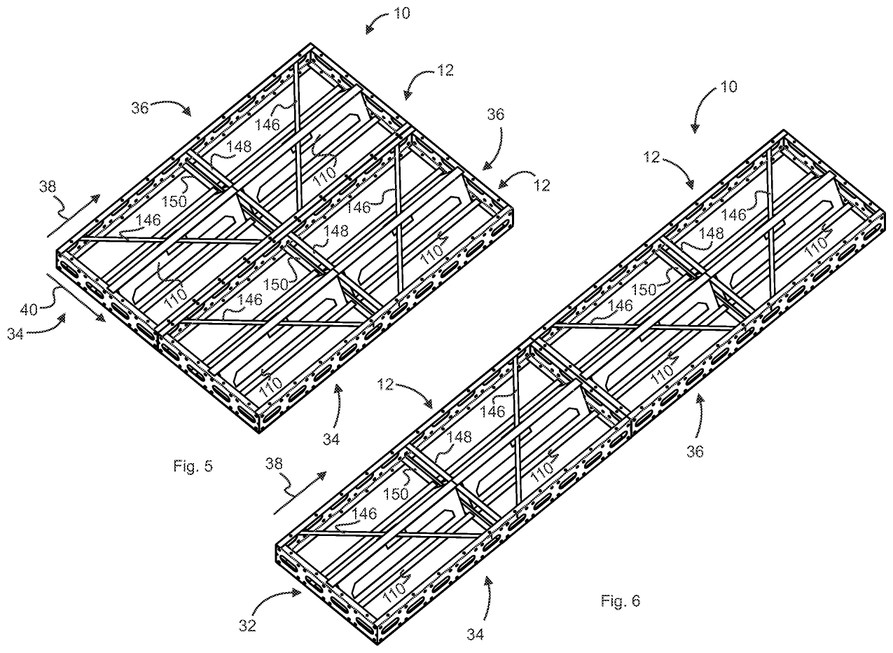

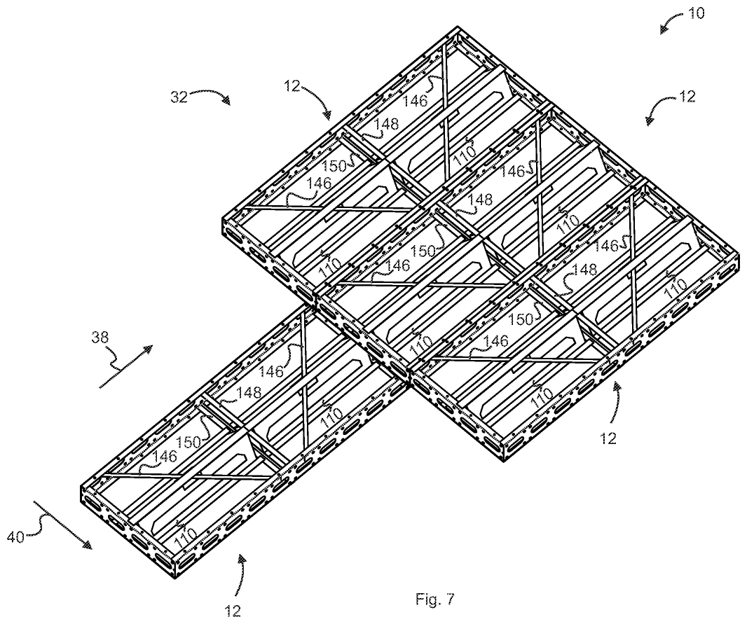

One feature of universal framing system 10 may be that each of the at least one standardized dock frames 12 may be configured to be assembled together with each other for creating boat dock 32. See FIGS. 5-9. Still referring to FIGS. 5-9, another feature of universal framing system 10 may be that each of the at least one standardized dock frames 12 may be configured to be modular. As shown best in FIGS. 5-6, the modular feature of the standardized dock frames 12 may be where a base standardized dock frame 34 of the at least one standardized dock frames 12 can be configured to be attached to at least one adjacent standardized dock frame 36 of the at least one standardized dock frames 12. This attachment of the two standardized dock fames 12 may be both in lengthwise direction 38 and in widthwise direction 40.

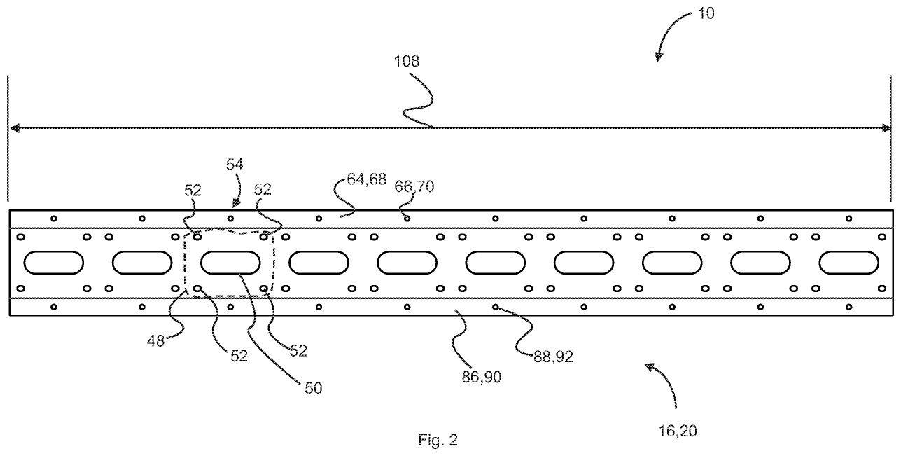

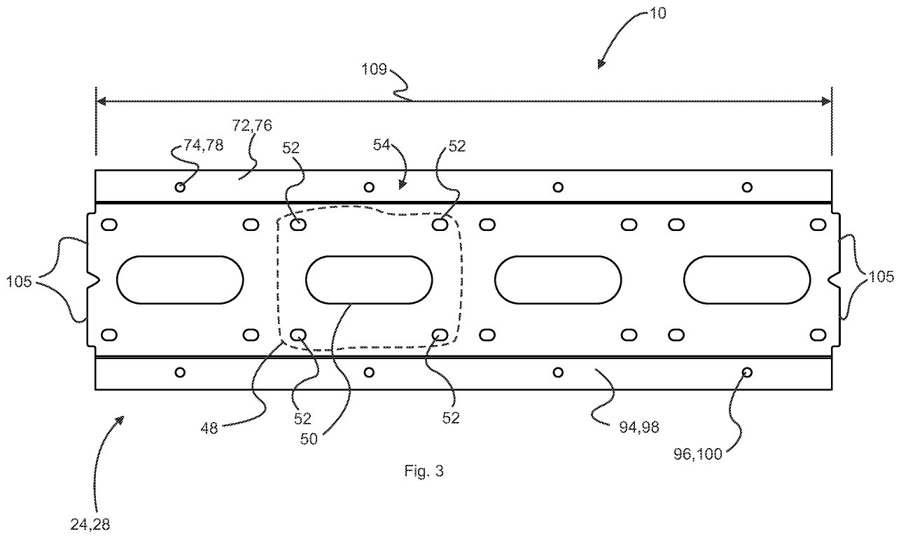

Another feature of universal framing system 10 may be that each of the at least one standardized dock frames 12 can include pattern of holes 42. The pattern of holes 42 may be around rectangular shape 14 of each standardized dock frame 12, like around the outside or perimeter of each standardized dock frame 12. The pattern of holes 42 may be configured for attaching each of the at least one standardized dock frames 12 to one another. As a result, the base standardized dock frame 34 may be configured to be attached to the at least one adjacent standardized dock frame 36 by using the included pattern of holes 42. The pattern of holes 42 being around the rectangular shape 14 may allow the attachment of the standardized dock frames 12 to be both in the lengthwise direction 38 and in the widthwise direction 40. The pattern of holes 42 may be any desired pattern or configuration of holes around standardized dock frame 12. In select embodiments, the pattern of holes 42 may include a plurality of attachment holes 44 and a plurality of slots 46 around rectangular shape 14. In select embodiments, the pattern of holes 42 may include at least one standard pattern 48. As shown best in FIGS. 2 and 3, the standard pattern 48 may include, but is not limited to, having central slot 50 and a plurality of surrounding holes 52 around central slot 50. Wherein, as shown in the Figures, standard pattern 48 may be repeated around rectangular shape 14 of each standardized dock frame 12. In select embodiments, standard pattern 48 may include central slot 50, and four surrounding holes 52 around central slot 50. These four surrounding holes 52 may create box shape 54 of the surrounding holes 52 around central slot 50. Wherein the plurality of attachment holes 44, the plurality of slots 46, or a combination thereof, may not only be configured for attaching a base standardized dock frame 34 to an adjacent standardized dock frame 36, but also may be configured for attaching flotation devices or accessories around boat dock 32.

Another feature of universal framing system 10 may be that the included plurality of slots 46 may be oval pockets 58. These oval pockets 58 may be configured as fork pockets 60 (like for standard fork lifts) for easy transport of standardized dock frame 12. These fork pockets may include galvanized relief holes.

As best shown in FIGS. 1-3, in select embodiments of universal framing system 10, standardized left side member 16 may include left top lip 64 with a plurality of left top holes 66. Standardized right side member 20 may include right top lip 68 with a plurality of right top holes 70. As shown in FIG. 2, the left top lip 64 and the right top lip 68 may be bent perpendicular to standardized left side member 16 and standardized right side member 20, respectively, after each of standardized left side member 16 and standardized right side member 20 are created and/or stamped. Likewise, standardized front end member 24 may include front top lip 72 with a plurality of front top holes 74. And standardized back end member 28 may include back top lip 76 with a plurality of back top holes 78. As shown in FIG. 3, the front top lip 72 and the back top lip 76 may be bent perpendicular to standardized front end member 24 and standardized back end member 28, respectively, after each of standardized front end member 24 and standardized back end member 28 are created and/or stamped. Wherein, rectangular top lip 80 having a plurality of rectangular top holes 82 may be created via left top lip 64, right top lip 68, front top lip 72, and back top lip 76. Wherein, rectangular top holes 82 may be configured for attaching decking material 84 84 (or other desired materials, objects, or devices) on top of rectangular shape 14 of each of the at least one standardized dock frames 12.

Still referring to FIGS. 1-3, as best shown in these Figures, in other select embodiments of universal framing system 10, standardized left side member 16 may include left bottom lip 86 with a plurality of left bottom holes 88. Standardized right side member 20 may include right bottom lip 90 with a plurality of right bottom holes 92. As shown in FIG. 2, the left bottom lip 86 and the right bottom lip 90 may be bent perpendicular to standardized left side member 16 and standardized right side member 20, respectively, after each of standardized left side member 16 and standardized right side member 20 are created and/or stamped. Standardized front end member 24 may include front bottom lip 94 with a plurality of front bottom holes 96. And standardized back end member 28 may include back bottom lip 98 with a plurality of back bottom holes 100. As shown in FIG. 3, the front bottom lip 94 and the back bottom lip 98 may be bent perpendicular to standardized front end member 24 and standardized back end member 28, respectively, after each of standardized front end member 24 and standardized back end member 28 are created and/or stamped. Wherein, rectangular bottom lip 102 having a plurality of rectangular bottom holes 104 may be created via left bottom lip 86, right bottom lip 90, front bottom lip 94, and back bottom lip 98. Wherein, rectangular bottom holes 104 may be configured for attaching decking material 84 (or other desired materials, objects, or devices) on bottom of rectangular shape 14 of each of the at least one standardized dock frames 12. Wherein, as shown in the Figures, in embodiments with both rectangular top lip 80 with rectangular top holes 82 and rectangular bottom lip 102 with rectangular bottom holes 104, each of the at least one standardized dock frames 12 may be configured to be reversible where rectangular top lip 80 or rectangular bottom lip 102 may be configured to be positioned upwards for attaching decking material 84 (or other desired materials, objects, or devices) on each of the at least one standardized dock frames 12. In select embodiments, rectangular top holes 82 and/or rectangular bottom holes 104 may have standard spacing 106. Standard spacing 106 between the rectangular top holes and/or the rectangular bottom holes 104 may be any desired standardized or repeated spacing. In select possibly preferred embodiments, standard spacing 106 may include, but is not limit to, a standard spacing of 1 foot.

Referring now specifically to FIGS. 2 and 3, in other select embodiments of universal framing system 10, standardized left side member 16 and standardized right side member 20 may include end protrusions 105. Or, standardized front end member 24 and standardized back end member 28 may include the end protrusions 105. Wherein, end protrusions 105 may be configured for attaching together standardized left side member 16, standardized right side member 20, standardized front end member 24, and standardized back end member 28 to create rectangular shape 14 of each of the standardized dock frames 12. As shown in FIG. 3, end protrusions 105 may be bent perpendicular to standardized left side member 16, standardized right side member 20, standardized front end member 24, and standardized back end member 28, respectively, after they are created and/or stamped.

As best shown in FIG. 1, another feature of universal framing system 10 may be that rectangular shape 14 of each of the standardized dock frames 12 may include length 108 and width 109. Length 108 and/or width 109 may be any desired size for creating any desired size of standardized dock frame 12. In select possibly preferred embodiments, but clearly not limited thereto, length 108 may be 10 feet, and width 109 may be 4 feet. Wherein, standardized left side member 16 and standardized right side member 20 have length 108 of 10 feet each with pattern of holes 42 including 10 standard patterns 48. And standardized front end member 24 and standardized back end member 28 may have width 109 of 4 feet each with pattern of holes 42 including 4 standard patterns 48.

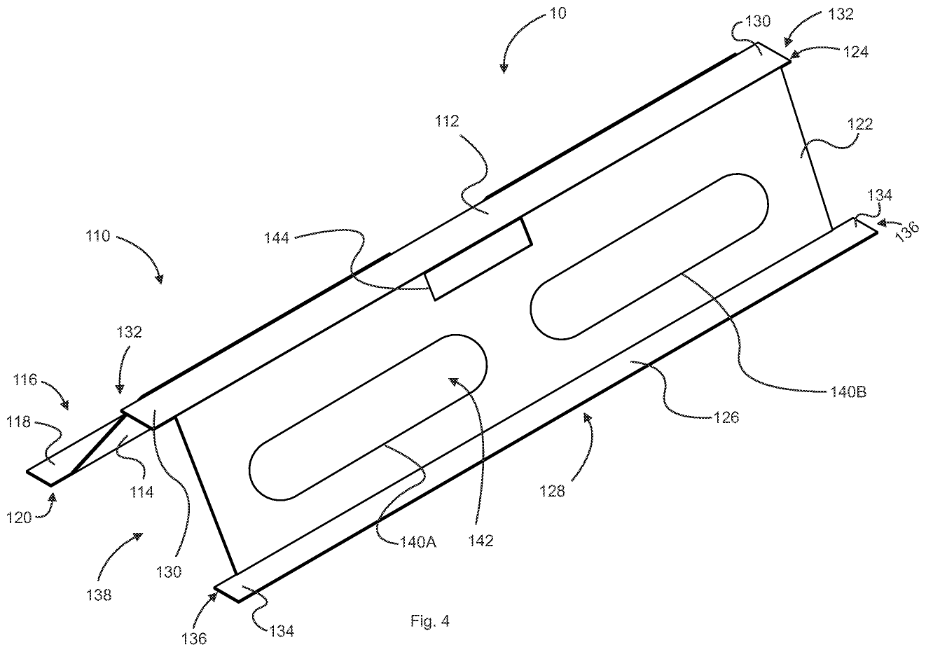

Referring now to FIGS. 1 and 4, another feature of universal framing system 10 may be the inclusion of at least one triangulated center truss 110. Triangulated center truss 110 may be configured to be used to support decking material 84 and/or for creating a more rigid standardized deck frame 12. Each of the triangulated center trusses 110 may include any components, members, or devices configured for supporting decking material 84 and/or for creating a more rigid standardized deck frame 12. In select embodiments, as best shown in FIG. 4, each of the at least one triangulated center trusses 110 may include flat top member 112, left angled side 114, and right angled side 122. Left angled side 114 may be connected to flat top member 112 at left triangle top 116 and may have flat left bottom member 118 attached to an opposite left bottom 120. Likewise, right angled side 122 may be connected to flat top member 112 at right triangle top 124 and may have flat right bottom member 126 attached to an opposite right bottom 128. Flat top member 112 may include top flanges 130 that extend beyond left angled side 114 and right angled side 122 on both top ends 132. Top flanges 130 may be configured for attaching flat top member 112 to rectangular top lip 80 of standardized dock frame 12. Flat left bottom member 118 and flat right bottom member 126 may include bottom flanges 134 that extend beyond left angled side 114 and right angled side 122 on both bottom ends 136. Bottom flanges 134 may be configured for attaching left angled side 114 and right angled side 122 to rectangular bottom lip 102 of standardized dock frame 12. Wherein, left angled side 114 and right angled side 122 create triangular shape 138 configured for supporting flat top member 112. One feature of universal framing system 10 may be that in select embodiments each of the left angled side 114 and right angled side 122 may include at least one elongated slot 140 and/or top slot 144. The at least one elongated slot 140 may be aligned with plurality of slots 46 along standardized left side member 16 and standardized right side member 20. Whereby, elongated slots 140 may be configured as fork pockets 142 with the plurality of slots 46 (like for transportation with standard fork lifts). As shown in FIGS. 1 and 5-7, in select embodiments, each triangulated center truss 110 may include a single elongated slot 140 that expands almost entirely across the length of triangulated center truss 110. As shown in FIG. 4, in select other embodiments, each triangulated center truss 110 may include two elongated slots 140A and 140B. Providing two elongated slots 140A and 140B (versus the single elongated slot 140) on each triangulated center truss 110 may add to the rigidity and structural reinforcement provided from triangulated center truss 110. Top slot 144 may be positioned just below flat top member 112. Top slot 144 may be configured to receive diagonal x-brace 146 therethrough.

As shown in the Figures, another feature of universal framing system 10 may be that in select embodiments at least two triangulated center trusses 110 may be included. These at least two triangulated center trusses 110 may be attached lengthwise, as best shown in FIG. 1. In these embodiments, flat top center brace 148 may be included that can be configured to support top flanges 130 of adjacent triangulated center trusses 110. Bottom center brace 150 may also be included that is configured to support bottom flanges 134 of left angled side 114 and right angled side 122 of the adjacent triangulated center trusses 110. Bottom center brace 150 may include vertical member 152 configured to space and align the adjacent triangulated center trusses 110.

As shown in the Figures, in select embodiments of universal framing system 10, when rectangular shape 14 of the at least one standardized dock frame 12 has width 109 of four feet, the at least one standardized dock frame 12 may include one triangulated center truss 110 between width 109 of standardized dock frame 12 configured to allow decking material 84 to be installed on 24″ centers. Not shown in the Figures, in select other embodiments of universal framing system 10, when rectangular shape 14 of the at least one standardized dock frame 12 has width 109 of four feet, the at least one standardized dock frame 12 may include two triangulated center trusses 110 between width 109 of standardized dock frame 12 configured to allow decking material to be installed on 16″ centers.

Referring to FIGS. 1 and 5-8, another feature of universal framing system 10 may be that each of the standardized dock frames 12 may further include diagonal x-braces 146 therethrough. Each of the diagonal x-braces 146 may be configured to be attached diagonally from left top lip 64 to right top lip 68 of rectangular shape 14 of standardized dock frame 12. In select embodiments, each of the diagonal x-braces 146 may pass through top slot 144 of triangulated center truss 110. Wherein, each of the diagonal x-braces 146 may be configured for added structural support to standardized dock frame 12.

Referring specifically to FIG. 1, in another aspect, the instant disclosure embraces standardized dock frame 12 of universal framing system 10 for boat dock 32. Standardized dock frame 12 may include any of the embodiments and/or combination of embodiments shown and/or described herein.

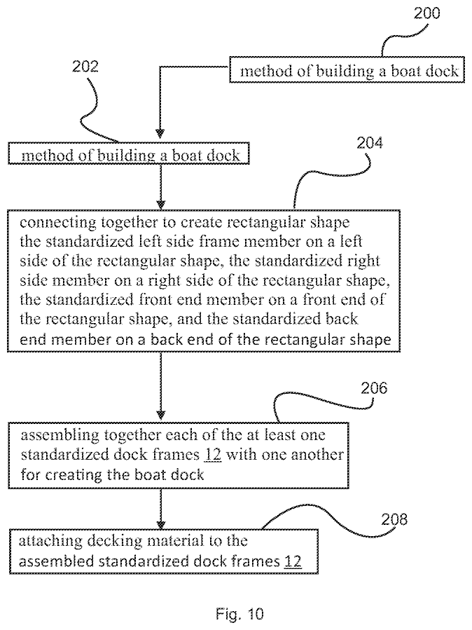

Referring now to FIG. 10, in another aspect, the instant disclosure embraces method 200 of building boat dock 32. Method 200 of building boat dock 32 may include utilizing universal framing system 10 in any of the embodiments and/or combination of embodiments shown and/or described herein. As such, method 200 of building boat dock 32 may generally include step 202 of providing at least one standardized dock frame 12 in any of the embodiments and/or combination of embodiments shown and/or described herein. As such, each of the provided standardized dock frames 12 may include: standardized left side member 16 on left side 18 of rectangular shape 14; standardized right side member 20 on right side 22 of rectangular shape 14; standardized front end member 24 on front end 26 of rectangular shape 14; and standardized back end member 28 on back end 30 of rectangular shape 14. With the provided components of standardized dock frame 12, method 200 of building boat dock 32 may further include step 204 of connecting together to create rectangular shape 14 the standardized left side member 16 on left side 18 of rectangular shape 14, standardized right side member 20 on right side 22 of rectangular shape 14, standardized front end member 24 on front end 26 of rectangular shape 14, and standardized back end member 28 on back end 30 of rectangular shape 14. Once connected, method 200 may further include step 206 of assembling together each of the at least one standardized dock frames 12 with one another for creating boat dock 32, and step 208 of attaching decking material 84 (or other desired materials, objects, or devices) to the assembled standardized dock frames 12.

In sum, the disclosed universal framing system 10 for boat dock 32 may include utilizing modular standardized frame 12 as a main structure, with pattern of holes 42 to attach adjacent frames 12 and to attach flotation devices, or the like, as well as decking material 84. Triangulated center truss 110 may be included and used for decking support. Diagonal x-brace 146 may also be included for added structural support of each of the modular standardized frames 12. Oval pockets 58 may be included as part of the pattern of holes 42 that can be configured as fork pockets 60 for easy transport with galvanized relief holes.

Accordingly, in one aspect, universal framing system 10 provides the ability to use the same standardized frame 12 for 16″ or 24″ decking material 84 with its universal modular frame design.

Another feature of universal framing system 10 may be its ability to lock in decking material 84 or flotation devices virtually anywhere on standardized frame 12 with its new bolt-hole pattern of holes 42.

Another feature of universal framing system 10 may be its completely triangulated design from triangulated center trusses 110 which may provide for a more structurally sound standardized frame 12.

Another feature of universal framing system 10 may be the oval pockets 58 used for efficient forklift transport and installation.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A universal framing system for a boat dock comprising:
at least one standardized dock frame in a rectangular shape, each of the at least one standardized dock frames including:
a standardized left side member on a left side of the rectangular shape;
a standardized right side member on a right side of the rectangular shape;
a standardized front end member on a front end of the rectangular shape; and
a standardized back end member on a back end of the rectangular shape;
the standardized left side member, the standardized right side member, the standardized front end member, and the standardized back end member are configured to connect together to create the rectangular shape.

2. The universal framing system of claim 1, wherein each of the at least one standardized dock frames are configured to be assembled together with each other for creating the boat dock.

3. The universal framing system of claim 2, wherein:
each of the at least one standardized dock frames is configured to be modular, where a base standardized dock frame of the at least one standardized dock frames is configured to be attached to at least one adjacent standardized dock frame of the at least one standardized dock frames, both in a lengthwise direction and in a widthwise direction; and
each of the at least one standardized dock frames including a pattern of holes around the rectangular shape configured for attaching each of the at least one standardized dock frames to one another, where the base standardized dock frame is configured to be attached to the at least one adjacent standardized dock frame, both in the lengthwise direction and in the widthwise direction via the pattern of holes around the rectangular shape of each of the standardized dock frames;
wherein the pattern of holes including a plurality of attachment holes and a plurality of slots around the rectangular shape.

4. The universal framing system of claim 3, wherein the pattern of holes including at least one standard pattern, each of the standard patterns including:
a central slot; and
a plurality of surrounding holes around the central slot;
wherein, the standard pattern is repeated around the rectangular shape;
wherein the plurality of attachment holes, the plurality of slots, or a combination thereof are configured for attaching flotation devices or accessories around the boat dock; and
wherein the plurality of slots are oval pockets configured as fork pockets for easy transport, with galvanized relief holes.

5. The universal framing system of claim 4, wherein the standard pattern including:
the central slot; and
four of the surrounding holes around the central slot creating a box shape of the surrounding holes around the central slot.

6. The universal framing system of claim 1, wherein:
the standardized left side member including a left top lip with a plurality of left top holes;
the standardized right side member including a right top lip with a plurality of right top holes;
the standardized front end member including a front top lip with a plurality of front top holes;
the standardized back end member including a back top lip with a plurality of back top holes;
wherein, a rectangular top lip having a plurality of rectangular top holes is created via the left top lip, the right top lip, the front top lip, and the back top lip, wherein, the rectangular top holes are configured for attaching decking material on top of the rectangular shape of each of the at least one standardized dock frames;
the standardized left side member including a left bottom lip with a plurality of left bottom holes;
the standardized right side member including a right bottom lip with a plurality of right bottom holes;
the standardized front end member including a front bottom lip with a plurality of front bottom holes;
the standardized back end member including a back bottom lip with a plurality of back bottom holes;
wherein, a rectangular bottom lip having a plurality of rectangular bottom holes is created via the left bottom lip, the right bottom lip, the front bottom lip, and the back bottom lip, wherein, the rectangular bottom holes are configured for attaching the decking material on bottom of the rectangular shape of each of the at least one standardized dock frames;
wherein, each of the at least one standardized dock frames is configured to be reversible where the rectangular top lip or the rectangular bottom lip is configured to be positioned upwards for attaching the decking material on each of the at least one standardized dock frames; and
wherein the rectangular top holes and the rectangular bottom holes have a standard spacing of 1 foot.

7. The universal framing system of claim 1, wherein the
the standardized left side member and the standardized right side member including end protrusions; or
the standardized front end member and the standardized back end member including the end protrusions;
wherein, the end protrusions are configured for attaching together the standardized left side member, the standardized right side member, the standardized front end member, and the standardized back end member to create the rectangular shape.

8. The universal framing system of claim 1, wherein the rectangular shape of each of the standardized dock frames including:
a length; and
a width.

9. The universal framing system of claim 8, wherein:
the length is 10 feet; and
the width is 4 feet;
wherein:
the standardized left side member and the standardized right side member have the length of 10 feet each with a pattern of holes including 10 standard patterns; and
the standardized front end member and the standardized back end member have the width of 4 feet each with a pattern of holes including 4 standard patterns.

10. The universal framing system of claim 1 further comprising at least one triangulated center truss, each of the at least one triangulated center trusses is configured to be used to support decking material.

11. The universal framing system of claim 10, wherein each of the at least one triangulated center trusses including:
a flat top member;
a left angled side connected to the flat top member at a left triangle top and having a flat left bottom member attached to an opposite left bottom; and
a right angled side connected to the flat top member at a right triangle top and having a flat right bottom member attached to an opposite right bottom;
the flat top member includes top flanges that extend beyond the left angled side and the right angled side on both top ends, the top flanges are configured for attaching the flat top member to a rectangular top lip of each of the at least one standardized dock frames;
the flat left bottom member and the flat right bottom member include bottom flanges that extend beyond the left angled side and the right angled side on both bottom ends, the bottom flanges are configured for attaching the left angled side and the right angled side to a rectangular bottom lip of each of the at least one standardized dock frames;
wherein, the left angled side and the right angled side create a triangular shape for supporting the flat top member;
wherein each of the left angled side and the right angled side including:
at least one elongated slot, each of the elongated slots are aligned with a plurality of slots along the standardized left side member and the standardized right side member, whereby the elongated slots are configured as fork pockets with the plurality of slots; and
a top slot positioned just below the flat top member, the top slot is configured to receive a diagonal x-brace therethrough; or
combinations thereof.

12. The universal framing system of claim 11 including:
at least two triangulated center trusses attached lengthwise;
a flat top center brace configured to support the top flanges of adjacent triangulated center trusses; and
a bottom center brace configured to support the bottom flanges of the left angled side and the right angled side, the bottom center brace including a vertical member configured to space and align the adjacent triangulated center trusses.

13. The universal framing system of claim 12, wherein, when the rectangular shape of the at least one standardized dock frame has a width of four feet, the at least one standardized dock frame includes:
one triangulated center truss between the width of the standardized dock frame configured to allow the decking material to be installed on 24″ centers; or
two triangulated center trusses between the width of the standardized dock frame configured to allow the decking material to be installed on 16″ centers.

14. The universal framing system of claim 1, wherein each of the standardized dock frames further including diagonal x-braces therethrough.

15. The universal framing system of claim 14, wherein each of the diagonal x-braces is configured to be attached diagonally from a left top lip to a right top lip of the rectangular shape of the standardized dock frame, where each of the diagonal x-braces pass through a top slot of a triangulated center truss, wherein each of the diagonal x-braces is configured for added structural support.

16. A standardized dock frame of a universal framing system for a boat dock comprising:
a standardized left side member on a left side of a rectangular shape;
a standardized right side member on a right side of the rectangular shape;
a standardized front end member on a front end of the rectangular shape; and
a standardized back end member on a back end of the rectangular shape;
the standardized left side member, the standardized right side member, the standardized front end member, and the standardized back end member are configured to connect together to create the rectangular shape.

17. The standardized dock frame of claim 16, wherein the standardized dock frame is configured to be assembled together with at least one additional standardized dock from for creating the boat dock.

18. The standardized dock frame of claim 16, wherein:
the standardized dock frame including a pattern of holes around the rectangular shape, the pattern of holes including a plurality of attachment holes and a plurality of slots around the rectangular shape, each of the standard patterns including:
a central slot; and
a plurality of surrounding holes around the central slot;
wherein, the standard pattern is repeated around the rectangular shape;
wherein the plurality of attachment holes, the plurality of slots, or a combination thereof are configured for attaching flotation devices or accessories around the boat dock;
wherein the plurality of slots are oval pockets configured as fork pockets for easy transport, with galvanized relief holes;
the standardized left side member including a left top lip with a plurality of left top holes;
the standardized right side member including a right top lip with a plurality of right top holes;
the standardized front end member including a front top lip with a plurality of front top holes;
the standardized back end member including a back top lip with a plurality of back top holes;
wherein, a rectangular top lip having a plurality of rectangular top holes is created via the left top lip, the right top lip, the front top lip, and the back top lip, wherein, the rectangular top holes are configured for attaching decking material on top of the rectangular shape of each of the at least one standardized dock frames;
the standardized left side member including a left bottom lip with a plurality of left bottom holes;
the standardized right side member including a right bottom lip with a plurality of right bottom holes;
the standardized front end member including a front bottom lip with a plurality of front bottom holes;
the standardized back end member including a back bottom lip with a plurality of back bottom holes;
wherein, a rectangular bottom lip having a plurality of rectangular bottom holes is created via the left bottom lip, the right bottom lip, the front bottom lip, and the back bottom lip, wherein, the rectangular bottom holes are configured for attaching the decking material on bottom of the rectangular shape of each of the at least one standardized dock frames;
wherein, each of the at least one standardized dock frames is configured to be reversible where the rectangular top lip or the rectangular bottom lip is configured to be positioned upwards for attaching the decking material on each of the at least one standardized dock frames;
wherein the rectangular top holes and the rectangular bottom holes have a standard spacing of 1 foot;
wherein the rectangular shape of the standardized dock frames including:
a length of 10 feet; and
a width of 4 feet;
wherein:
the standardized left side and the standardized right side member have the length of 10 feet each with a pattern of holes including 10 standard patterns; and
the standardized front end member and the standardized back end member have the width of 4 feet each with a pattern of holes including 4 standard patterns;
at least one triangulated center truss, each of the at least one triangulated center trusses is configured to be used to support the decking material, each of the at least one triangulated center trusses including:
a flat top member;
a left angled side connected to the flat top member at a left triangle top and having a flat left bottom member attached to an opposite left bottom; and
a right angled side connected to the flat top member at a right triangle top and having a flat right bottom member attached to an opposite right bottom;
the flat top member includes top flanges that extend beyond the left angled side and the right angled side on both top ends, the top flanges are configured for attaching the flat top member to the rectangular top lip of the standardized dock frame;
the flat left bottom member and the flat right bottom member include bottom flanges that extend beyond the left angled side and the right angled side on both bottom ends, the bottom flanges are configured for attaching the left angled side and the right angled side to the rectangular bottom lip of the standardized dock frame;
wherein, the left angled side and the right angled side create a triangular shape for supporting the flat top member;
wherein each of the left angled side and the right angled side including:
at least one elongated slot, each of the elongated slots are aligned with a plurality of slots along the standardized left side member and the standardized right side member, whereby the elongated slots are configured as fork pockets with the plurality of slots; and
a top slot positioned just below the flat top member, the top slot is configured to receive a diagonal x-brace therethrough; or
combinations thereof; and
at least one of the diagonal x-brace, each of the at least one diagonal x-braces is configured to be attached diagonally from the left top lip to the right top lip of the rectangular shape of the standardized dock frame, where each of the diagonal x-braces pass through the top slot of each of the at least one triangulated center truss, wherein each of the diagonal x-braces is configured for added structural support.

19. The standardized dock frame of claim 18 including:
at least two of the at least one triangulated center trusses attached lengthwise;
a flat top center brace configured to support the top flanges of adjacent triangulated center trusses; and
a bottom center brace configured to support the bottom flanges of the left angled side and the right angled side, the bottom center brace including a vertical member configured to space and align the adjacent triangulated center trusses;
wherein, with the rectangular shape of the at least one standardized dock frame having the width of four feet, the standardized dock frame includes:
one triangulated center truss between the width of the standardized dock frame configured to allow the decking material to be installed on 24″ centers; or
two triangulated center trusses between the width of the standardized dock frame configured to allow the decking material to be installed on 16″ centers.

20. A method of building a boat dock including:
providing at least one standardized dock frame, each of the standardized dock frames including:
a standardized left side member on a left side of the rectangular shape;
a standardized right side member on a right side of the rectangular shape;
a standardized front end member on a front end of the rectangular shape;
a standardized back end member on a back end of the rectangular shape;
connecting together to create a rectangular shape the standardized left side member on the left side of the rectangular shape, the standardized right side member on the right side of the rectangular shape, the standardized front end member on the front end of the rectangular shape, and the standardized back end member on the back end of the rectangular shape;
assembling together each of the at least one standardized dock frames with one another for creating the boat dock; and
attaching decking material to the assembled standardized dock frames.
